(19) United States
(12) Patent Application Publication
(10) Pub. No.: US 2023/0230139 A1
(43) Pub. Date: Jul. 20, 2023

(54) System and Method of Personalization for Online Marketplaces

(71) Applicant: Completeful Technologies, LLC, Lafayette, LA (US)

(72) Inventor: Joshua Goree, Lafayette, LA (US)

(21) Appl. No.: 18/156,190

(22) Filed: Jan. 18, 2023

Related U.S. Application Data
(60) Provisional application No. 63/300,315, filed on Jan. 18, 2022.

(51) Int. Cl. G06Q 30/0601

(52) U.S. Cl. CPC G06Q 30/0621

(57) ABSTRACT

A system or method for personalizing a product through the use of an online marketplace. A personalization system that allows a customer to personalize and specify a design on a product and accepts the information that has been input by the customer. The personalization system sends the customer's personalized product to a vendor that is able to accept and produce the customer's personalized product.

### BACKGROUND OF THE INVENTION

### Field of the Invention

The present invention pertains to a system and method of personalization on a variety of different products through an online marketplace. More particularly, the present invention pertains to a process of directly personalizing a product through the use of a plurality of different text boxes and images on a website, or other web server.

### Brief Description of the Prior Art

Customization of a product is the manufacturing ability to offer a variety of designs or details for one product, made specifically to a buyer's liking. Customization of a product means that a customer can select a variety of different features, such as, for example, color, design, functionalities, add-on components, or other options in order to make a more unique item rather than a mass-produced item.

In contrast, personalization of a product allows a buyer to embellish a product with his or her own content. This often takes the form of personalized text or images through a specific interface that allows a buyer to visualize and select his or her options.

Typically, current and conventional personalization websites (such as, for example, Etsy and Amazon) allow a vendor to sell a personalized item but do not have an interface that is available to allow a customer to fully customize the item. Mostly, these conventional personalization websites only have a single text field that tells the vendor what specific text to put on the particular personalized item at the request of the customer. In addition, these conventional personalization websites do not provide a means to allow a customer to be able to submit his or her own artwork to be used to personalize the item, or do not provide a means to allow a customer to make multiple customizations or personalizations at once.

Alternatively, the system and method of the present invention provides a means for a customer to be able to fully customize an item with any text, any image, or any personal artwork that the customer desires.

### SUMMARY OF THE PRESENT INVENTION

While the present invention will be described with reference to preferred embodiments, it will be understood by those skilled in the art that various changes may be made and equivalents may be substituted for elements thereof without departing from the scope of the present invention. In addition, many modifications may be made to adapt a particular situation or material to the teachings of the invention without departing from the essential scope thereof. Therefore, it is intended that the present invention not be limited to the particular embodiments disclosed as the best mode contemplated for carrying out this invention, but that the invention will include all embodiments (and legal equivalents thereof).

The present invention pertains to a method of personalization, or a personalization process, for use in a variety of different online marketplaces. More particularly, the present invention pertains to a process that can allow for an online vendor and/or distributor to have the ability to move and add an array of text boxes and images to any kind of printable product. In addition, the present invention comprises a program, or process, that allows a customer to completely customize an item and to receive a copy of a mockup, or draft, of what said item will look like before said item is shipped out to said customer.

In a preferred embodiment, when an end customer orders a particular customizable item, generally, one of these three things can happen:
1. A fulfillment company can look at the order and decide what needs to be printed on the item based on the end customer's notes that were typed in the text box;
2. A vendor can look at the order and decide what needs to be printed on the item based on the end customer's notes that were typed in the text box; or
3. The vendor does not know how to complete the design based on the end customer's notes, so the vendor then forwards the personalization tool of the present invention to the end customer to get clarification on the design.

As such, after an end customer places a particular customizable order for an item, either the end customer would be emailed a link to complete the design process for that item, or a fulfillment company would try and determine what design to apply to the items based on the end customer's notes. In a preferred embodiment, once the particular design is approved, the design is then automatically converted into a variety of multiple formats for a particular machine, wherein said machine is able to apply said design to said particular customizable item.

For example, if a customer is searching for a gift and has a specific design that he or she wants printed on said gift, with the personalization tool of the present invention, the customer can order the quantity of gifts that he or she needs, and in the text field that is provided by the vendor website (Etsy, Amazon, etc.), the customer can tell the vendor what he or she wants printed on the gift item. Since the vendor website does not actually print the items, the vendor sends the message to a manufacturing and fulfillment company, who then prints the items on behalf of the vendor website. When the vendor sends the order to the fulfillment company, the fulfillment company's designers read the personalized and customizable notes from the end customer and decide if they can understand what needs to be printed based on the end customer's notes. If the designer can decipher the customer's notes, they will make the design and print it on the gift item. If the designer cannot decipher the notes, the designer will then rely on the vendor website to decide what the end customer wants. If the vendor knows what the customer wants, then the vendor can design it. If the vendor does not know what the customer wants, then the vendor can send the design back to the end customer so that the end customer can comment or revise the design, as needed, to get the design exactly as desired by the end customer.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an image of a preferred embodiment of a personalization website on a computer screen illustrating a means for a customer to personalize a product through the personalization system of the present invention.

FIG. 2 depicts an image of a preferred embodiment of a personalization website on a computer screen illustrating the customer's personalized text on the product image.

FIG. 3 depicts an image of a preferred embodiment of a personalization website on a computer screen illustrating the customer's product information, as selected and personalized.

### DETAILED DESCRIPTION OF A PREFERRED EMBODIMENT

The present invention pertains to a process that can allow for an online vendor and/or distributor to have the ability to move and add an array of text boxes and images to any kind of printable product. In addition, the present invention comprises a program, or process, that allows a customer to completely personalize an item and to receive a copy of a mockup, or draft, of what said item will look like before said item is shipped out to said customer.

As used herein, a “customer” refers to a person that uses the website of the present invention for purposes of personalizing a product and purchasing said personalized product. The words “customer”, “user”, and “buyer” can be used interchangeably. The word “vendor” refers to a manufacturer of said products.

In a preferred embodiment, the present invention comprises the use of a computer, and any associated systems and applications, to perform the underlying method of personalization as described herein. A computer may be any modern-day computer comprising at least one processing element, typically a central processing unit in the form of a microprocessor, along with some type of computer memory, that allows for access to the Internet. The computer may additionally comprise a computer system, including, but not limited to, hardware, an operating system, and any peripheral equipment needed and used for full operation.

In addition, the computer comprises a variety of different types of computer programs and associated data, or software, that allows the computer to perform specific functions beyond the basic operation of the computer itself. Generally, a user interacts with different types of application software on the computer. The application software then interfaces with the operating system of the computer, which in turn communicates with the hardware of the computer. The component parts of the computer advantageously communicate with each other in order to perform the specific functions as disclosed herein.

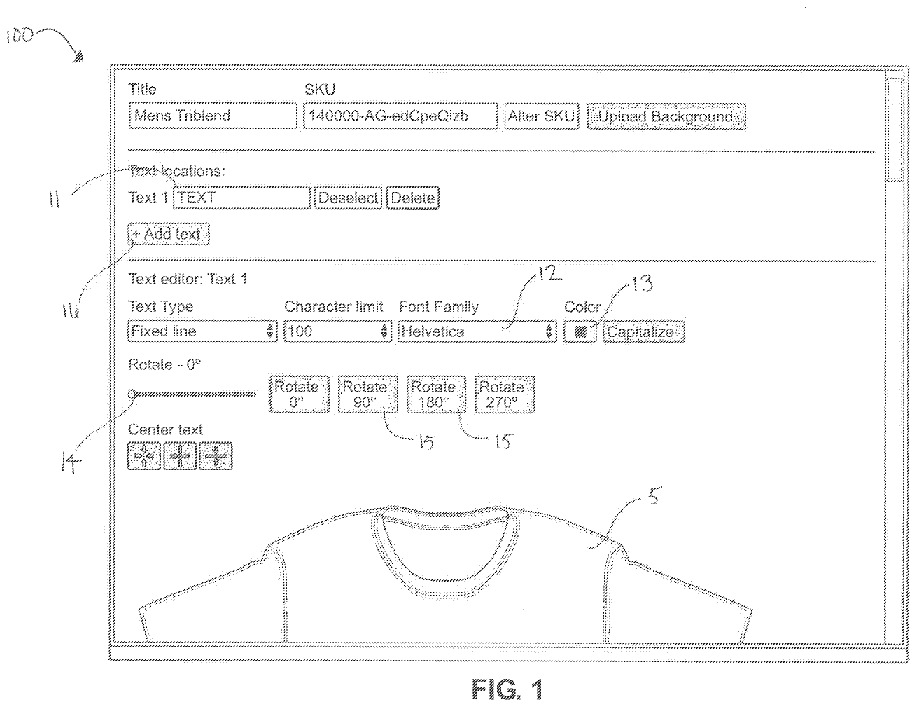

Referring back to the drawings, FIG. 1 depicts an image of a computer screen illustrating a means for a customer to personalize a product 5. For example purposes only, FIG. 1 depicts an image of a t-shirt that is to be personalized; however it is to be noted that any type of product could be interchangeably used. In a preferred embodiment, the present invention comprises an application software program 100 that allows a user to specifically personalize a product 5, and then allows a vendor to receive the information that was input by the customer.

As depicted in FIG. 1, the website provides a product personalization page 100 that comprises a plurality of text boxes 11 that allow the customer to fill in the designated information. The customer can input the information into the text boxes 11 that he or she wants to be displayed on the product 5. The customer has the option to change or adjust font style 12, font size, font color 13, and font location of the text on the product image 5 through the use of said text boxes 11 and the selection of various dropdown menus. The customer can also rotate the text or move the text through the selection of the rotation bar 14 and buttons 15, as desired. In addition, the customer can also upload or submit his or her own artwork or image to use in the personalization by way of the add text button 16. This allows the customer to be able to insert any image of his or her choosing directly onto the website and then directly onto the product image 5. The add text button 16 also allows a customer to incorporate multiple customizations at once by being able to add more than one text box 21 or more than one image or artwork to the product image 5.

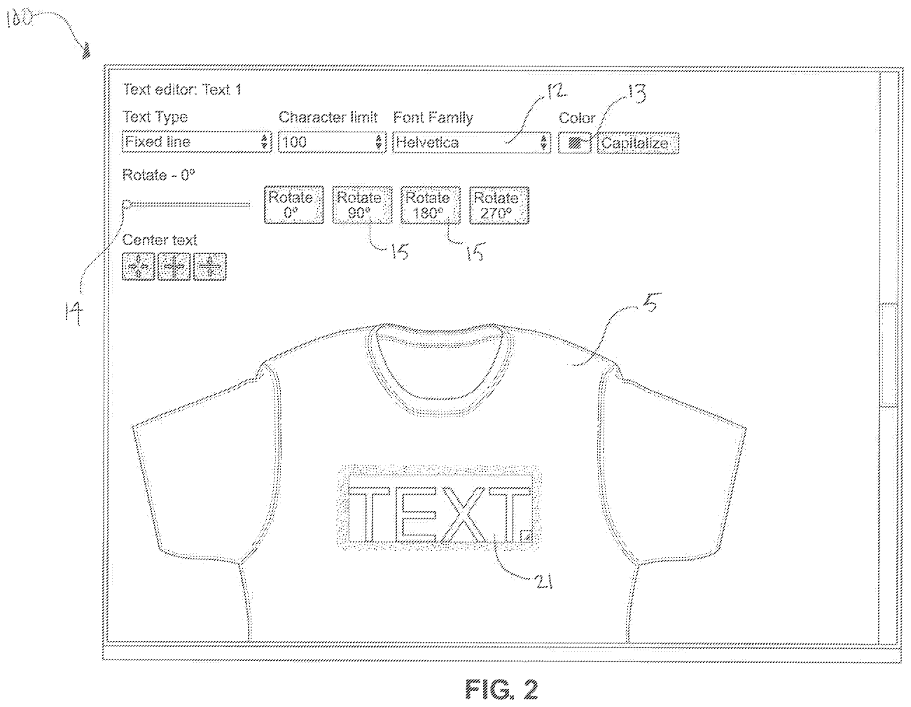

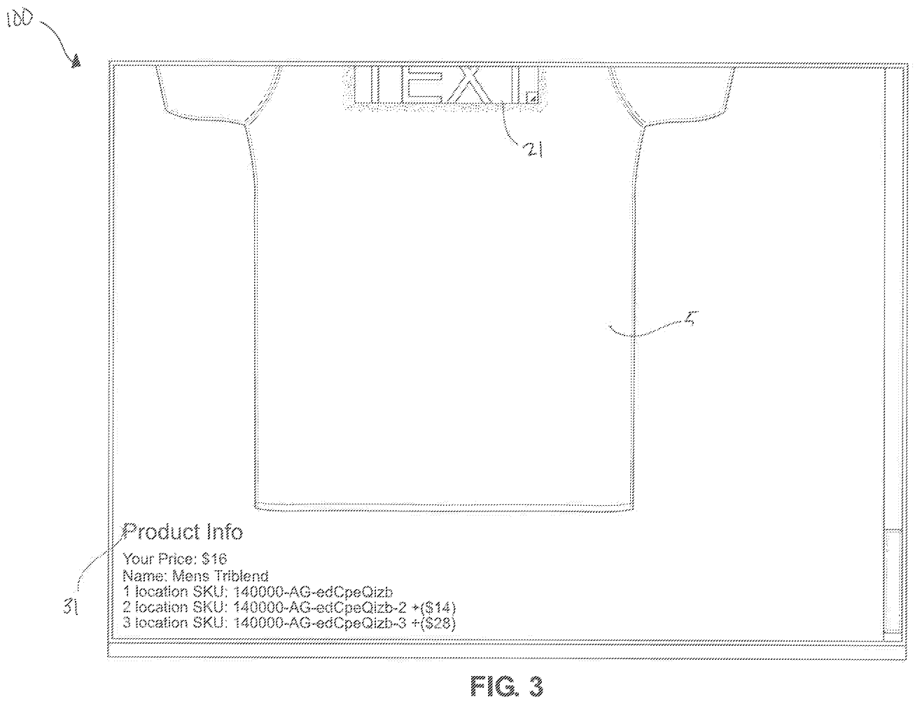

FIG. 2 depicts an image of a computer screen 100 illustrating the customer's personalized text 21 on the product image 5, and FIG. 3 depicts an image of a computer screen 100 illustrating the customer's product information 31, as selected. As depicted in FIG. 2, the information that has been input from the customer into the text boxes 11 will then be displayed for viewing on an image 21 of the product 5 itself. This allows the customer to be able to view the personalized product in real time and make any changes to the personalization as necessary. The customer can move the text box 21 on the product 5 image to any location that is desired.

Once the customer submits the information for the personalized product through the personalization interface 100, the vendor will receive the information along with a detailed description of the specific personalization and product that the customer has selected and requested. The information is then converted in a variety of different formats depending on the type of machinery that will be applying the personalized design onto the product. Since the vendor does not actually print the products or items, the vendor sends the customer's personalized message to a manufacturing and fulfillment company, who then prints the items on behalf of the vendor website.

When the vendor sends the order to the fulfillment company, the fulfillment company's designers read the personalized and customized notes from the customer and decide if the customer's personalized text can be understood. The fulfillment company then determines what needs to be printed based on the customer's notes. If the designer can decipher the customer's notes, they will make the design and print it on the product. If the designer cannot decipher the customer's notes, the designer will then rely on the vendor to decide what the customer has requested. If the vendor knows what the customer wants, then the vendor can design it. If the vendor does not know what the customer wants, then the vendor can send the design back to the customer so that the customer can comment or revise the design, as needed, to get the design exactly as desired by the customer.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of personalization in an online marketplace, comprising:
a) Using a computer that is adapted to allow for access to the internet;
b) Opening an internet browser and accessing a personalization website;
c) Selecting a particular product type that is to be personalized; and
d) Adding a personalized message or image to said particular product type.
